(19) United States
(12) Patent Application Publication
(10) Pub. No.: US 2025/0283526 A1
(43) Pub. Date: Sep. 11, 2025

(54) SYSTEM AND METHOD FOR SERVO MOTOR OUTPUT ANGLE MEASUREMENT WITH A MECHANICAL COUNTER SYSTEM ON DRIVER SIDE

(71) Applicant: happy droid, Inc., San Mateo, CA (US)

(72) Inventor: Sinan Filiz, San Mateo, CA (US)

(73) Assignee: happy droid, Inc., San Mateo, CA (US)

(21) Appl. No.: 19/073,563

(22) Filed: Mar. 7, 2025

Related U.S. Application Data
(60) Provisional application No. 63/562,847, filed on Mar. 8, 2024.

(51) Int. Cl. F16H 19/08; F16H 57/02; F16H 57/021; G01D 5/12; H02K 7/116; H02K 11/215; H02K 21/22

(52) U.S. Cl. CPC F16H 19/08; F16H 57/021; G01D 5/12; H02K 7/116; H02K 11/215; H02K 21/22; F16H 2057/02034; F16H 2057/02073

(57) ABSTRACT

Systems and methods including a servo comprising a gearbox, a servo output, a first encoder, a first encoder input, a second encoder, and a second encoder input. The servo output can be positioned on an output side of the gearbox. The first encoder and the second encoder may be positioned on a board side of the gearbox. The first encoder input and the second encoder input may be configured to communicate with the first encoder and the second encoder respectively. The first encoder input may be mechanically coupled to the gearbox. The second encoder input may be mechanically coupled to the first encoder input. The output side of the gearbox may be opposite the board side of the gearbox.

### CROSS-REFERENCE TO RELATED APPLICATIONS

This application is a non-provisional of and claims priority to U.S. Provisional Application No. 63/562,847 filed Mar. 8, 2024, which is herein incorporated by this reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

This disclosure relates generally to measuring servo outputs, and more specifically to measuring an output angle of a servo in robotics applications.

### BACKGROUND

Quasi-direct drive servo actuators have become popular in robotics applications. Quasi-direct drive servo actuators may be built with a low ratio gearbox, which may enable a dynamic robot with fast and natural movement. Quasi-direct drive servo actuators may also be back driven, which may assist in joint flexibility and reliability in case of impact to a robot.

Servo actuators, such as quasi-direct drive servo actuators, that use a gearbox generally are not capable of measuring the actuator output angular position. A rotor will require multiple turns compared to a single rotation of an output plate due to the gearbox ratio of the gearbox. When a servo motor with an unknown actuator output angular position is used on a robot, the system is unaware of the position of the robot joint. As a result, the robot will be required to run a calibration procedure upon startup, which may be time consuming, undesirable, and unreliable.

Installation of an encoder on the output side of the servo, i.e. the side proximate to the output plate, would enable the actuator output angular position to be measured. Generally, a motor driver electrical board is located on the opposite side of the servo from the output plate. In order to place an encoder on the output side of the servo, the electrical and communicative connections would need to be routed through the servo and an additional electrical board would need to be installed on the output side of the servo. As a result, system would become less modular, more complicated, more expensive, and less reliable. Further, the output range of the servo may become limited due to the output side encoder board connections.

Therefore, in view of the above, there is a need for a system and method to measure output angular position of a servo from the motor driver electrical board side of the servo.

### SUMMARY

A number of embodiments can include a servo. The servo can include a gearbox, a servo output, a first encoder, a first encoder input, a second encoder, and a second encoder input. The servo output can be positioned on an output side of the gearbox. The first encoder and the second encoder can be positioned on a board side of the gearbox. The first encoder input can be configured to communicate with the first encoder and can be mechanically coupled to the gearbox. The second encoder input can be configured to communicate with the second encoder and mechanically coupled to the first encoder input. The output side of the gearbox can be opposite the board side of the gearbox.

According to various embodiments, the first encoder input can be mechanically coupled to the gearbox by a first gear. The first gear can be fixedly coupled to the gearbox. The first encoder input can be fixedly coupled to the first gear. The first encoder input can be mechanically linked to the second encoder input by a second gear. The second gear can be mechanically coupled to the first gear. The second encoder input can be fixedly coupled to the second gear. The first gear can have t₁ teeth. The second gear can have t₂ teeth. A gear ratio of the gearbox can be represented by g. An integer can be represented by n. In various embodiments, t₁/t₂=n+ (1/g).

According to various embodiments, the servo can include a third gear. The third gear can be mechanically coupled between the first gear and the second gear. The third gear can be configured to act as a mechanical transmission element. The first encoder and the second encoder can be independently chosen from a diametric magnet encoder, a multi-pole magnetic encoder, an optical encoder, or a capacitive encoder. The first encoder and the second encoder can each comprise a diametric magnet encoder. The first encoder input and the second encoder input can each comprise a diametric magnet. The gearbox can comprise a planetary gearbox, a harmonic gearbox, or a cycloidal gearbox. The gearbox can comprise a planetary gearbox. The planetary gearbox can include a sun gear, a sun gear pin, and one or more planet gears. The sun gear pin can comprise a hollow shaft. The hollow shaft can be configured to allow electrical wires to be routed through a middle of the servo.

According to various embodiments, the servo can include a timing belt. The first encoder input can be mechanically coupled to the gearbox by a first timing belt pulley. The first timing belt pulley can be fixedly coupled to the gearbox. The first encoder input can be fixedly coupled to the first timing belt pulley. The second encoder input can be fixedly coupled to a second timing belt pulley. The first timing belt pulley can be mechanically coupled to the second timing belt pulley by the timing belt. The first encoder input can be directly coupled to the gearbox.

Various embodiments include a method of using a system to determine a servo output position. The method can include rotating, by a gearbox, a servo output of a servo. The method can include in response to the rotating, changing a set position of a first encoder input and a second encoder input. The first encoder input and the second encoder input can be mechanically coupled to the gearbox. The method can include detecting, by a first encoder, a first position of the first encoder input. The method can include detecting, by a second encoder, a second position of the second encoder input. The method can include calculating, by one or more processors, an output angular position associated with the rotation of the servo output based on the first position and the second position.

According to various embodiments, the changing the set position of the first encoder input can be by a first gear having t₁ teeth. The first gear can be mechanically coupled between the gearbox and the first encoder input. The changing the set position of the second encoder input can be by a second gear having t₂ teeth. The second gear can be mechanically coupled between the first gear and the second encoder input. A gear ratio of the gearbox can be represented by g. An integer can be represented by n. In various embodiments, t₁/t₂=n+ (1/g).

According to various embodiments, the method can include turning the servo off for a period of time. The method can include after the period of time, turning the servo on. The method can include repeating the steps of changing, detecting, and calculating. In various embodiments, a calibration procedure is not performed by the servo following the servo turning on. The first encoder and the second encoder can be positioned on a first side of the gearbox. The servo output can be positioned on a second side of the gearbox. The first encoder input and the second encoder input can each comprise a diametric magnet. The first encoder and the second encoder can each comprise a diametric magnet encoder.

A number of embodiments can include a servo. The servo can include a gearbox, a servo output, first encoder, and a second encoder. The servo output can be positioned on an output side of the gearbox. The first encoder and the second encoder can be positioned on a board side of the gearbox. The first encoder and the second encoder can be mechanically coupled to the gearbox and can be configured to determine an angular position of the servo output. The output side of the gearbox can be opposite the board side of the gearbox.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

To facilitate further description of the embodiments, the following drawings are provided in which:

FIG. 1 illustrates a system for measuring the output angle of a servo motor, with the second encoder assembly omitted for clarity, according to an embodiment.

FIG. 2A illustrates a cross-sectional view of a system having two gears to mechanically couple a first and a second encoder input, according to an embodiment.

FIG. 2B illustrates a bottom view of the two gears of FIG. 2A, according to an embodiment.

FIG. 3A illustrates a cross-sectional view of a system for measuring the output angle of a servo motor with a hollow shaft, according to an embodiment.

FIG. 3B illustrates a bottom view of the hollow shaft of FIG. 3A, according to an embodiment.

FIG. 4A illustrates a cross-sectional view of a system having three gears to mechanically couple a first and a second encoder input, according to an embodiment.

FIG. 4B illustrates a bottom view of the three gears of FIG. 4A, according to an embodiment.

FIG. 5A illustrates a cross-sectional view of a system having a timing belt and timing belt pulleys to mechanically couple a first and a second encoder input, according to an embodiment.

FIG. 5B illustrates a bottom view of the timing belt and timing belt pulleys of FIG. 5A, according to an embodiment.

FIG. 6 illustrates a cross-sectional view of a system with the first encoder input coupled directly to the rotor, the rotor coupled to a first gear and between the first gear and the first encoder input, and a second gear coupled to a servo housing using a retaining ring.

FIG. 7 illustrates a flowchart for a method of using a system to determine a servo output position, according to an embodiment.

### DETAILED DESCRIPTION

Disclosed herein are systems and methods for measuring an actuator output angular position (OP). Exemplary systems and methods may incorporate secondary mechanical counter architectures on a servo. In various embodiments, such secondary mechanical counter architectures may be low cost, modular, and easy to assemble and maintain. In various embodiments, a first encoder and a second encoder may be used to determine OP.

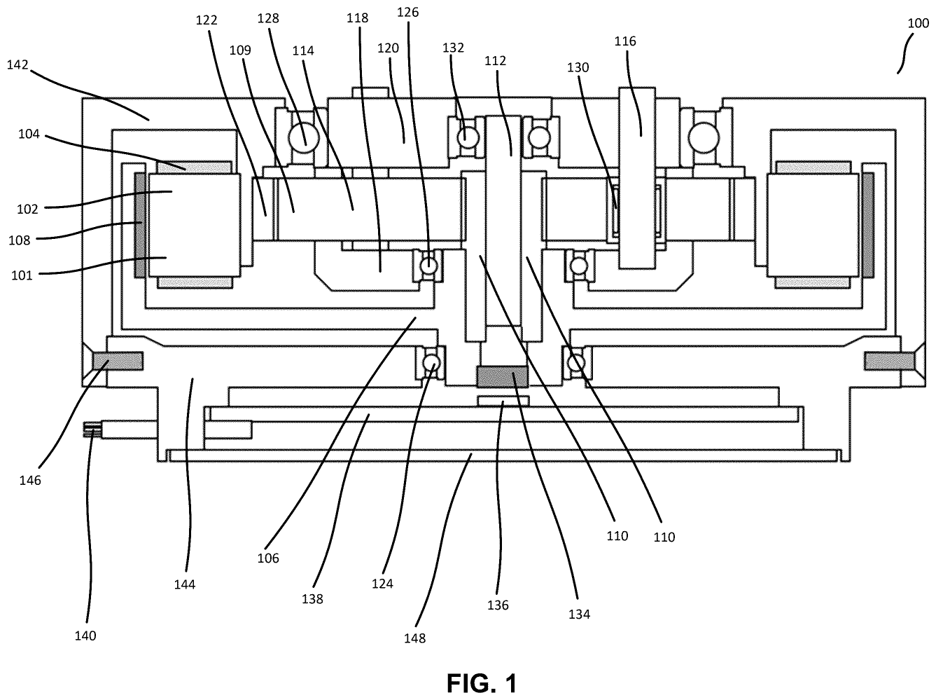

Turning to the drawings, FIG. 1 illustrates an exemplary embodiment of a servo 100 for measuring the OP of a servo motor, with the second encoder assembly omitted for clarity. Servo 100 is merely exemplary and is not limited to the embodiments presented herein. Servo 100 can be employed in many different embodiments or examples not specifically depicted or described herein. In some embodiments, the elements of servo 100 can be coupled in the arrangement presented. In other embodiments, the elements of servo 100 can be coupled in any suitable arrangement. In still other embodiments, one or more of the elements of servo 100 can be combined or omitted.

In various embodiments, servo 100 may include a stator 101 comprising stator metal 102 and stator windings 104. In various embodiments, a rotor 106 may be positioned about the stator 101. Rotor 106 may comprise rotor magnet 108. In various embodiments, a gearbox 109 can be installed inline with the stator 101, i.e., the gearbox 109 is not nested in the stator 101. In various embodiments, the gearbox 109 can be nested in the stator 101. In various embodiments, the gearbox 109 can comprise a planetary gearbox, a harmonic gearbox, or a cycloidal gearbox. In various embodiments, the gearbox 109 can comprise a planetary gearbox. The planetary gearbox can comprise a sun gear 110, also known as a pinion gear, a sun gear pin 112, a planet gear 114, a planet gear pin 116, a planet gear carrier 118, an output plate 120, and a ring gear 122. One or more planet gears 114 may be mechanically coupled to ring gear 122. One or more planet gears 114 may be mechanically coupled to sun gear 110. Sun gear pin 112 may extend from sun gear 110, for example, perpendicularly to the plane of rotation of gearbox 109. The planet gear pin 116 may be used to coupled planet gear 114 to planet gear carrier 118. Planet gear carrier 118 may couple one or more planet gears 114 to sun gear 110. Planet gear carrier 118 may be mechanically coupled to output plate 120. Planet gear carrier 118 may be configured to transfer a mechanical rotation from one or more planet gears 114 and/or sun gear 110 to output plate 120. Planet gear carrier 118 may be coupled to rotor 106 by a bearing 126. Output plate 120 may be coupled to sun gear 110 and/or sun gear pin 112 by a bearing 132. Sun gear 110 and/or one or more planet gears 114 may be mechanically coupled to a bearing 130. Bearing 130 may be a needle roller bearing. Gearbox 109 may have a gearbox ratio “g.”

In various embodiments, servo 100 may include a front housing 142. Front housing 142 may be coupled to planet gear carrier 118 by one or more bearings 128. Bearing 128 may be a ball bearing. The front housing 142 may be proximate to the output side of servo 100. In various embodiments, servo 100 may include a rear housing 144. The rear housing 144 may be proximate to the board side of servo 100. Rear housing 144 may be fixedly coupled to front housing 142 by one or more screws 146. Rear housing 144 may be coupled to the rotor 106 by one or more bearings 124. Rear housing 144 may have an aperture configured to allow wire connections 140 to pass through rear housing 144. Wire connections 140 may comprise power wires. Wire connections 140 may comprise signal wires. Wire connections 140 may comprise power and signal wires. In various embodiments, wire connections 140 can comprise any suitable wires for connecting to and/or communicating with motor driver board 138. In this manner, wire connections 140 can pass through rear housing 144 to communicate with and/or provide power to motor driver board 138. Motor driver board 138 can be positioned substantially within rear housing 144. Driver board cover 148 may seal motor driver board 138 within rear housing 144 and may provide physical protection to motor driver board 138.

Motor driver board 138 may be located on a board side of servo 100. Motor driver board 138 may include a first encoder 136. A first encoder input 134 may be coupled to rotor 106 and configured to communicate with the first encoder 136. In this manner, the rotor 106 position may be measured with a high degree of accuracy. Such measurement may be beneficial in efficiently driving the servo 100. For example, in embodiments that make use of field-oriented control, the magnetic fields of the rotor 106 and the stator 101 may be precisely aligned. In such embodiments, it may be desirable to measure rotor 106 position accurately. In various embodiments, first encoder 136 may be any suitable encoder type, for example, a multi-pole magnetic encoder, an optical encoder, or a capacitive encoder. In various embodiments, first encoder input 134 may be selected to communicate with the selected encoder type of first encoder 136. In various embodiments, first encoder 136 may be a diametric magnet encoder and first encoder input 134 may be a diametric magnet. For example, the first encoder input 134 may be a diametrically magnetized magnet and may be coupled on the rotor 106 facing the motor driver board 138, upon which first encoder 136 is positioned. Positioning the first encoder 136 on the motor driver board 138 may provide a modular servo 100 in which parts may be easily replaced if needed.

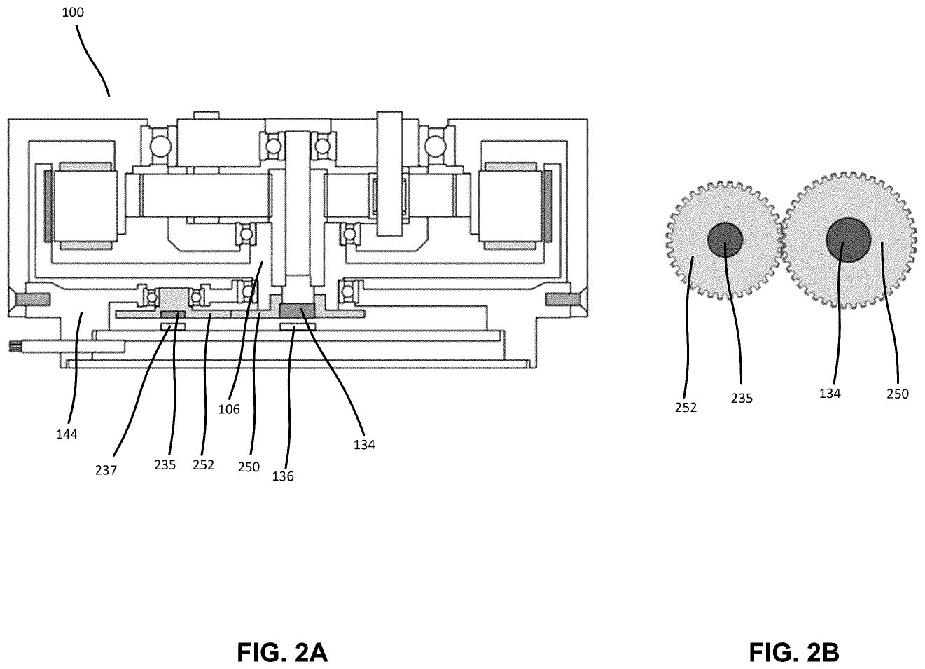

With reference to FIG. 2A, a cross-sectional view of a system having a first gear 250 and a second gear 252 to mechanically couple a first encoder input 134 and a second encoder input 235 is shown. In various embodiments, the first encoder input may be fixedly coupled to the first gear 250. In various embodiments, the first gear 250 may be fixedly and/or rigidly coupled to rotor 106. The first gear 250 may be mechanically coupled to the second gear 252. For example, rotation of the first gear 250 may in turn rotate the second gear 252. In various embodiments, the second gear 252 may be coupled to the rear housing 144 and may be configured to freely rotate. In various embodiments, the second gear 252 may be coupled to the servo 100 in any manner suitable to allow the second gear 252 to be mechanically coupled to first gear 250 and to freely rotate. A second encoder input 235 may be mechanically coupled to the first encoder input 134. In various embodiments, the second encoder input 235 may be fixedly coupled to the second gear 252. The second encoder input 235 may be configured to communicate with a second encoder 237. The second encoder 237 may be located on a board side of the servo 100. In various embodiments, the second encoder 237 may be positioned on the motor driver board 138. In various embodiments, the second encoder 237 may be any suitable encoder type, for example, a multi-pole magnetic encoder, an optical encoder, or a capacitive encoder. In various embodiments, the second encoder input 235 may be selected to communicate with the selected encoder type of the second encoder 237. In various embodiments, the second encoder 237 may be a diametric magnet encoder and the second encoder input 235 may be a diametric magnet.

In various embodiments, the number of gear teeth for the first gear 250 and the second gear 252 may be represented by the formula t₁/t₂=n+ (1/g), where t₁ represents the number of teeth for the first gear 250, t₂ represents the number of teeth for the second gear 252, n is an integer which represents the number of full rotations of the second gear for the first gear to rotate once, and g represents the gear ratio of the gearbox 109 (FIG. 1). In various embodiments, t₁ and t₂ may be integers. In this manner, the first encoder 136 and the second encoder 237 will provide equivalent readings at rotor 106 rotation zero, i.e., before rotor 106 has rotated, and at each g times rotation of rotor 106. Each g times rotation of rotor 106 may be equivalent to one rotation of the output plate 120 (FIG. 1). In the intermediate rotor 106 rotations between each g times rotation of rotor 106, i.e., when rotor 106 has rotated less than g times, the first gear 250 and/or the first encoder input 134 will have a different angle of rotation than the second gear 252 and/or the second encoder input 235 from rotor 106 rotation zero, providing a unique angle combination given by the reading of the first encoder 136 and the reading of the second encoder 237. A processor or other suitable computing device may determine the OP based on the unique angle combination.

With reference to FIG. 2B, a bottom view of the first gear 250 and the second gear 252 shown in FIG. 2A is shown. The number of gear teeth for the first gear 250 and the second gear 252 may be represented by the formula t₁/t₂=n+ (1/g), as described above with respect to FIG. 2A. The first encoder input 134 may be fixedly coupled to the first gear 250, for example on a side of the first gear 250 proximate to the motor driver board 138 (FIG. 1). The second encoder input 235 may be fixedly coupled to the second gear 252, for example on a side of the second gear 252 proximate to the motor driver board 138 (FIG. 1).

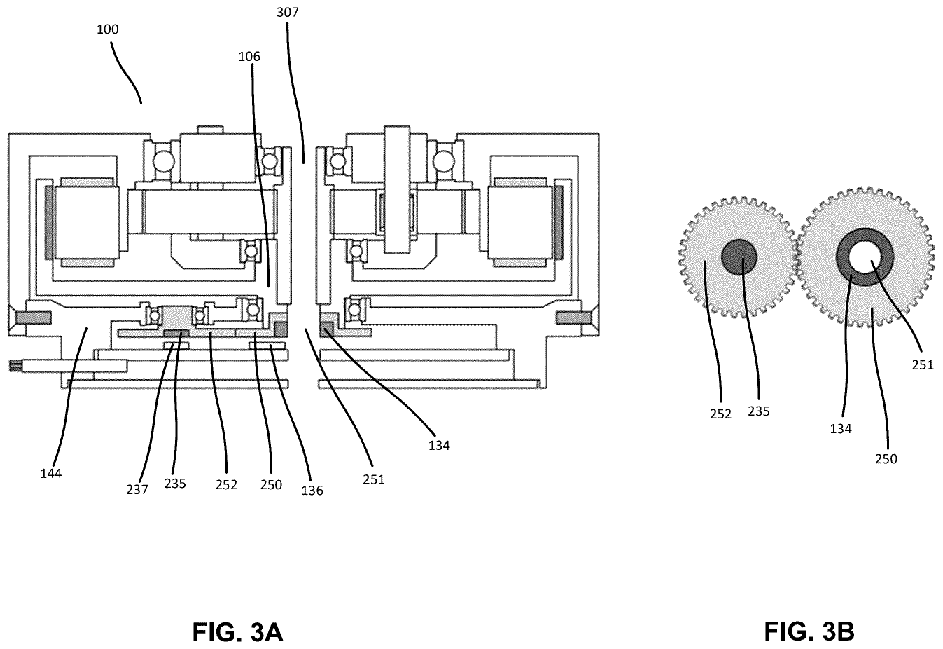

With reference to FIG. 3A, in various embodiments, the servo 100 may include a hollow shaft 307. A hollow shaft 307 may allow for routing of wires, such as electrical wires, or other components through the middle of the servo 100. For example, a hollow shaft 307 may be desirable in applications where multiple servos 100 are assembled together, such as those where a multi-degree-of-freedom joint is desired. A hollow shaft 307 may reduce complexity and difficulty of managing service loops of wires by providing a space for service loops of wires within the servo 100.

In various embodiments, the first gear 250 may have an aperture 251 configured to accommodate the hollow shaft 307. The first encoder input 134 may comprise a ring-shaped magnet. The ring-shaped magnet may fixedly coupled to the first gear 250 and may be positioned about the aperture 251 such that wires may be routed through the first encoder input 134 and the first gear 250. The first encoder 136 may be configured to communicate with the first encoder input 134 in an off-axis configuration, i.e. the first encoder 136 may be aligned in a manner other than on a common axis with the first encoder input 134. In various embodiments, the first encoder 136 may comprise one or more encoders in an off-axis configuration. First encoder 136 may be any suitable encoder type, for example, a multi-pole magnetic encoder, an optical encoder, or a capacitive encoder. In various embodiments, use of more than one off-axis configured encoder may be beneficial for reducing interferences in the measurement and/or in making the measurement more accurate. In various embodiments, the first gear 250 may be fixedly and/or rigidly coupled to the rotor 106. The first gear 250 may be mechanically coupled to the second gear 252. For example, rotation of the first gear 250 may in turn rotate the second gear 252. In various embodiments, the second gear 252 may be coupled to the rear housing 144 and may be configured to freely rotate. In various embodiments, the second gear 252 may be coupled to the servo 100 in any manner suitable to allow the second gear 252 to be mechanically coupled to the first gear 250 and to freely rotate. In various embodiments, the second encoder input 235 may be fixedly coupled to the second gear 252. The second encoder input 235 may be configured to communicate with a second encoder 237. The second encoder 237 may be located on a board side of the servo 100. In various embodiments, the second encoder 237 may be positioned on the motor driver board 138. Second encoder 137 may be any suitable encoder type, for example, a multi-pole magnetic encoder, an optical encoder, or a capacitive encoder.

With reference to FIG. 3B, a bottom view of the first gear 250 and the second gear 252 shown in FIG. 3A is shown. The number of gear teeth for the first gear 250 and the second gear 252 may be represented by the formula t₁/t₂=n+ (1/g), as described above with respect to FIG. 2A. In various embodiments, the first gear 250 may have an aperture 251 configured to accommodate the hollow shaft 307. In various embodiments, the aperture 251 may be centrally located on the first gear 250. The first encoder input 134 may be fixedly coupled to the first gear 250, for example on a side of the first gear 250 proximate to the motor driver board 138 (FIG. 1). The first encoder input 134 may be a ring-shaped magnet. The ring-shaped magnet may be positioned on first gear 250 and about aperture 251. The second encoder input 235 may be fixedly coupled to the second gear 252, for example on a side of the second gear 252 proximate to the motor driver board 138 (FIG. 1).

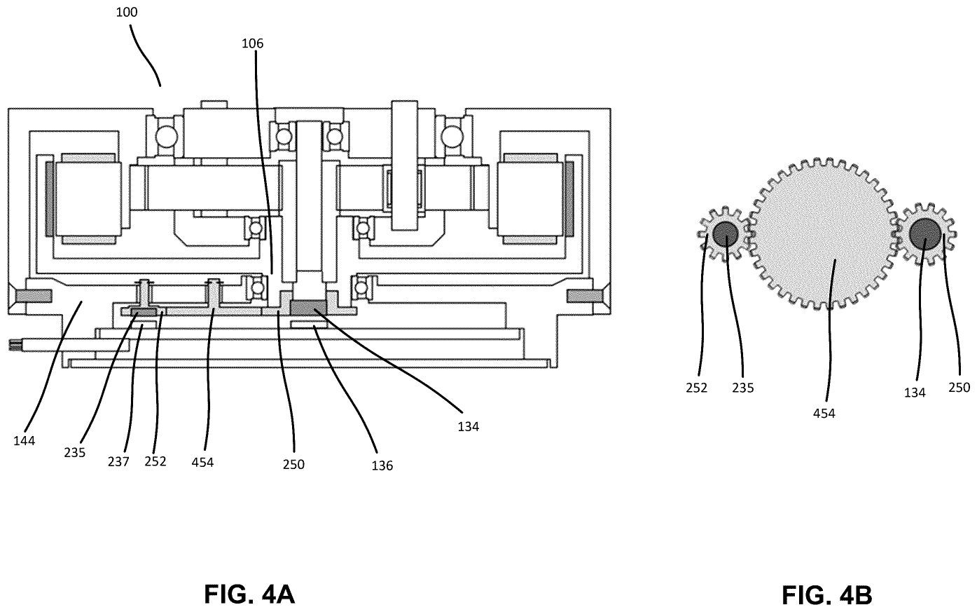

With reference to FIG. 4A, a cross-sectional view of a system having a first gear 250, a second gear 252, and a third gear 454 to mechanically couple a first encoder input 134 and a second encoder input 235 is shown. A third gear 454 may be desirable in applications where the first encoder input 134 and the second encoder input 235 are desirably separated, such as in smaller servos 100. Separation of the first encoder input 134 and the second encoder input 235 may reduce magnetic field interference between the first encoder input 134 and the second encoder input 235. In this manner, the accuracy of the readings provided by the first encoder 136 and the second encoder 237 may be increased. The first encoder 136 and the second encoder 237 may independently be any suitable encoder type, for example, a multi-pole magnetic encoder, an optical encoder, or a capacitive encoder.

In various embodiments, the first gear 250 may be fixedly coupled to the rotor 106. The first encoder input 134 may be fixedly coupled to the first gear 250, for example on a side of the first gear 250 proximate to the motor driver board 138 (FIG. 1). The first gear 250 may be mechanically coupled to the third gear 454. For example, rotation of the first gear 250 may in turn rotate the third gear 454. The third gear 454 may be mechanically coupled to the second gear 252. For example, rotation of the third gear 454 may in turn rotate the second gear 252. In this manner, the third gear 454 may act as a mechanical transmission element between the first gear 250 and the second gear 252. The number of gear teeth for the first gear 250 and the second gear 252 may be represented by the formula t₁/t₂=n+ (1/g), as described above with respect to FIG. 2A. The third gear 454 may have any number of teeth. In various embodiments, the third gear 454 may provide separation between the first gear 250 and the second gear 252, and thus, the first encoder input 134 and the second encoder input 235. In various embodiments, the third gear 454 may be larger than the first gear 250 and/or the second gear 252. In various embodiments, the third gear 454 may be substantially the same size as the first gear 250 and/or the second gear 252. In various embodiments, the third gear 454 may be coupled to the rear housing 144 and may be configured to freely rotate.

With reference to FIG. 4B, a bottom view of the first gear 250, the second gear 252, and the third gear 454 shown in FIG. 4A is shown. The number of gear teeth for the first gear 250 and the second gear 252 may be represented by the formula t₁/t₂=n+ (1/g), as described above with respect to FIG. 2A. The third gear 454 may have any number of teeth. In various embodiments, increasing the number of teeth of the third gear 454 may increase the separation between the first gear 250 and the second gear 252, and thus between the first encoder input 134 and the second encoder input 235. The first encoder input 134 may be fixedly coupled to the first gear 250, for example on a side of the first gear 250 proximate to the motor driver board 138 (FIG. 1). The second encoder input 235 may be fixedly coupled to the second gear 252, for example on a side of the second gear 252 proximate to the motor driver board 138 (FIG. 1).

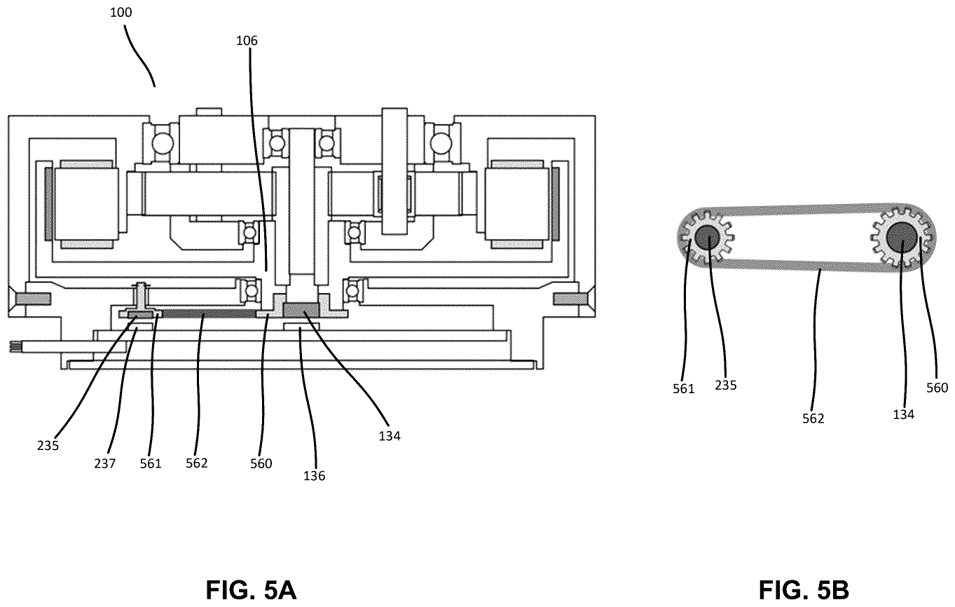

With reference to FIG. 5A, a cross-sectional view of a system having a timing belt 562, a first timing belt pulley 560, and a second timing belt pulley 561 to mechanically couple a first encoder input 134 and a second encoder input 235 is shown. A timing belt 562 may be desirable in applications where the first encoder input 134 and the second encoder input 235 are desirably separated, such as in smaller servos 100. Separation of the first encoder input 134 and the second encoder input 235 may reduce magnetic field interference between the first encoder input 134 and the second encoder input 235. In this manner, the accuracy of the readings provided by the first encoder 136 and the second encoder 237 may be increased. The first encoder 136 and the second encoder 237 may independently be any suitable encoder type, for example, a multi-pole magnetic encoder, an optical encoder, or a capacitive encoder.

In various embodiments, the first timing belt pulley 560 may be fixedly coupled to the rotor 106. The first encoder input 134 may be fixedly coupled to the first timing belt pulley 560, for example on a side of the first timing belt pulley 560 proximate to the motor driver board 138 (FIG. 1). The first timing belt pulley 560 may be mechanically coupled to the second timing belt pulley 561 by a timing belt 562. The number of teeth for the first timing belt pulley 560 and the second timing belt pulley 561 may be represented by the formula t₁/t₂=n+ (1/g), where t₁ represents the number of teeth for the first timing belt pulley 560, t₂ represents the number of teeth for the second timing belt pulley 561, n is an integer which represents the number of full rotations of the second timing belt pulley for the first timing belt pulley to rotate once, and g represents the gear ratio of the gearbox 109 (FIG. 1). In this manner, the timing belt pulleys 560, 561 and the timing belt 562 may employ the working principle of the first gear 250, second gear 252, and third gear 454 of FIG. 4. The timing belt 562 acts as a mechanical transmission element between the first timing belt pulley 560 and the second timing belt pulley 561.

With reference to FIG. 5B, a bottom view of the first timing belt pulley 560, the second timing belt pulley 561, and the timing belt 562 shown in FIG. 5A is shown. The number of teeth for the first timing belt pulley 560 and the second timing belt pulley 561 may be represented by the formula t₁/t₂=n+ (1/g), as described above with respect to FIG. 5A. The timing belt 562 may mechanically couple the first timing belt pulley 560 and the second timing belt pulley 561. The timing belt 562 may act as a mechanical transmission element, and may increase the separation between the first timing belt pulley 560 and the second timing belt pulley 561, and thus between the first encoder input 134 and the second encoder input 235. The first encoder input 134 may be fixedly coupled to the first timing belt pulley 560, for example on a side of the first timing belt pulley 560 proximate to the motor driver board 138 (FIG. 1). The second encoder input 235 may be fixedly coupled to the second timing belt pulley 561, for example on a side of the second timing belt pulley 561 proximate to the motor driver board 138 (FIG. 1).

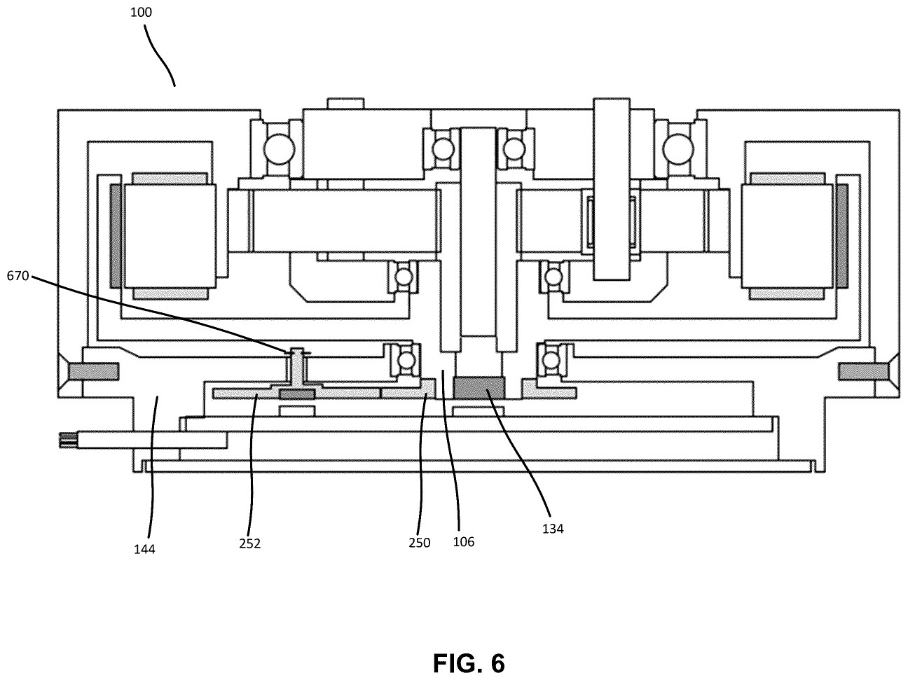

With reference to FIG. 6, a cross-sectional view of a system with the first encoder input 134 coupled directly to the rotor 106, the rotor 106 coupled to a first gear 250 and between the first gear 250 and the first encoder input 134, and a second gear 252 coupled to the rear housing 144 using a retaining ring 670. In this manner, the first encoder input 134 and the first gear 250 may both be directly coupled to the rotor 106. Further, it is shown that the bearing 253 (FIG. 2) may be replaced by a retaining ring 670 to couple the second gear 252 to the rear housing 144. It is understood that second gear 252, third gear 454 (FIG. 4), and second timing belt pulley 561 (FIG. 5) may each be coupled to the servo 100 by a bearing 253 (FIG. 2), a retaining ring 670, or by any other suitable way of coupling a component to rear housing 144. In various embodiments, second gear 252, third gear 454 (FIG. 4), and second timing belt pulley 561 (FIG. 5) may be configured to freely rotate with respect to rear housing 144.

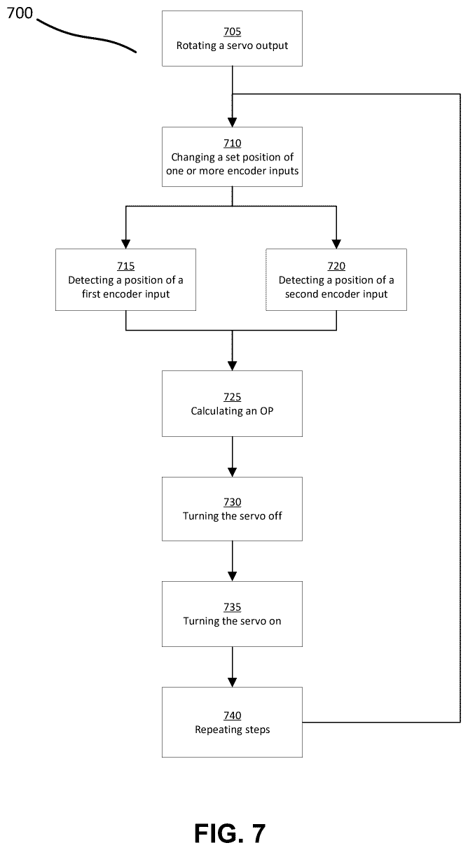

With reference to FIG. 7, a flow chart for a method 700 is illustrated according to an embodiment. Method 700 is merely exemplary and is not limited to the embodiments presented herein. Method 700 can be employed in many different embodiments or examples not specifically depicted or described herein. In some embodiments, the activities of method 700 can be performed in the order presented. In other embodiments, the activities of method 700 can be performed in any suitable order. In still other embodiments, one or more of the activities of method 700 can be combined or skipped. In many embodiments, servo 100 (FIG. 2) can be suitable to perform method 700 and/or one or more of the activities of method 700. In these or other embodiments, one or more of the activities of method 700 can be implemented as one or more computer instructions configured to run at or on one or more processing modules and configured to be stored at or on one or more non-transitory memory storage modules. Such non-transitory memory storage modules can be part of a computer system.

In various embodiments, step 705 may comprise rotating, by a gearbox, a servo output of a servo. The gearbox may be gearbox 109. The servo may be servo 100. The servo output may be output plate 120. The rotation may be any number of rotations. The rotation may be a complete rotation or a partial rotation of the servo output. In various embodiments, the rotation may be more than one complete rotation of the servo output.

In various embodiments, step 710 may comprise changing a set position of a first encoder input and a second encoder input. The first encoder input and the second encoder input may be mechanically coupled to the gearbox. The first encoder input may be first encoder input 134. The first encoder input may be a diametric magnet. The second encoder input may be second encoder input 235. The second encoder input may be a diametric magnet. The first encoder input and the second encoder input may be any suitable encoder input for communicating with a chosen first encoder and a chosen second encoder. The changing of the set position of the first encoder input and the second encoder input may be in response to the rotating of the servo output. The changing of the set position of the first encoder input may be by a first gear having t₁ teeth. The first gear may be first gear 250. The first gear may be mechanically coupled between the gearbox and the first encoder input. The changing of the set position of the second encoder input may be by a second gear having t₂ teeth. The second gear may be second gear 252. The second gear may be mechanically coupled between the first gear and the second encoder input. The number of gear teeth for the first gear 250 and the second gear 252 may be represented by the formula t₁/t₂=n+ (1/g), as described above with respect to FIG. 2A.

In various embodiments, step 715 may comprise detecting a first position of the first encoder input by a first encoder. The first encoder may be first encoder 136. The first encoder may comprise a diametric magnet encoder. The first encoder may comprise any suitable encoder type, for example, the first encoder may be a multi-pole magnetic encoder, an optical encoder, a capacitive encoder, or any other suitable encoder. The first encoder may be positioned on a first side of the gearbox. In various embodiments, step 720 may comprise detecting a second position of the second encoder input by a second encoder. The second encoder may be second encoder 237. The second encoder may comprise a diametric magnet encoder. The second encoder may comprise any suitable encoder type, for example, the second encoder may be a multi-pole magnetic encoder, an optical encoder, a capacitive encoder, or any other suitable encoder. The second encoder may be positioned on a first side of the gearbox. The servo output may be positioned on a second side of the gearbox. In various embodiments, step 715 and step 720 may be performed simultaneously. In various embodiments, step 715 and step 720 may be performed sequentially. In various embodiments, one of step 715 and step 720 may be omitted. In various embodiments, both step 715 and step 720 may be performed before step 725 is performed.

In various embodiments, step 725 may comprise calculating an OP associated with the rotation of the servo output based on the first position and the second position, by one or more processors. The calculating may be based on a unique angle combination provided by the first position and the second position for a partial rotation of the servo output. The calculating may be performed by a processing module. A processing module can comprise a processor. The processor can be configured to communicate with one or more non-transitory memory storage modules. The OP may be calculated by the formula OP=(a₁/g)+quotient {mod [a₂−a₁×(n+1/g), 360], (360/g)}× (360/g), where a₁ represents an angle reading from the first encoder, such as first encoder 136, of the first encoder input, such as first encoder input 134, where a₂ represents an angle reading from the second encoder, such as second encoder 237, of the second encoder input, such as second encoder input 235, where g represents a gear ratio of the gearbox, and where n is an integer which represents the number of full rotations of the second gear for the first gear to rotate once.

Generally speaking, the processor can comprise any suitable type of computational circuit. For example, the processor can comprise a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, a application specific integrated circuits (ASIC), or the like. The processor can be configured to implement (e.g., run or execute) computer instructions (e.g., program instructions) stored on memory devices in system 100. At least a portion of the program instructions, stored on these devices, can be suitable for carrying out at least part of the techniques and methods described herein. Architecture and/or design of the processor can be compliant with any of a variety of commercially distributed architecture families. For example, a processor can have a 32-bit (x86) architecture and/or a 64-bit (x86-64, IA64, and/or AMD64) architecture. The processor can be configured to perform parallel computing in combination with other elements of system 100 and/or additional processors. Generally speaking, parallel computing can be seen as a technique where multiple elements of system 100 are used to perform calculations simultaneously. In this way, complex and repetitive tasks (e.g., training a predictive algorithm) can be performed faster and with less processing power than without parallel computing.

Generally speaking, a memory storage can comprise non-volatile memory (e.g., read only memory (ROM)) and/or volatile memory (e.g., random access memory (RAM)). The non-volatile memory can be removable and/or non-removable non-volatile memory. Meanwhile, RAM can comprise dynamic RAM (DRAM), static RAM (SRAM), or some other type of RAM. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), or some other type of ROM. A memory storage can comprise non-transitory memory and/or transitory memory. All or a portion of the memory storage can be referred to as memory storage module(s) and/or memory storage device(s). The memory storage can have a number of form factors when used in system 100. For example, the memory storage can comprise a magnetic disk hard drive, a solid state hard drive, a removable USB storage drive, a RAM chip, etc.

The memory storage can be encoded with a wide variety of computer code configured to operate system 100. For example, portions of the memory storage can be encoded with a boot code sequence suitable for restoring system 100 to a functional state after a system reset. As another example, portions of the memory storage can comprise microcode such as a Basic Input-Output System (BIOS) operable with elements of system 100. Further, portions of the memory storage can comprise an operating system (e.g., a software program that manages the hardware and software resources of a computer and/or a computer network). The BIOS can be configured to initialize and test components of system 100 and load the operating system. Meanwhile, the operating system can perform basic tasks such as, for example, controlling and allocating memory, prioritizing the processing of instructions, controlling input and output devices, facilitating networking, and/or managing files. Exemplary operating systems can comprise software within the Microsoft® Windows®, Mac OS®, Apple® iOS®, Google® Android®, UNIX®, and/or Linux® series of operating systems.

A network adapter can be configured to connect system 100 to a computer network by wired communication (e.g., a wired network adapter) and/or wireless communication (e.g., a wireless network adapter). A network adapter can be integrated into one or more chassis, circuit boards, and/or buses or be removable (e.g., via a PCI slot on a motherboard). For example, a network adapter can be implemented via one or more dedicated communication chips configured to receive various protocols of wired and/or wireless communications.

In many embodiments, system 100 (FIG. 2) can be suitable to perform method 700 and/or one or more of the activities of method 700. In these or other embodiments, one or more of the activities of method 700 can be implemented as one or more computer instructions configured to run at or on one or more processing modules and configured to be stored at or on one or more non-transitory memory storage modules.

In various embodiments, step 730 may comprise turning the servo off for a period of time. The period of time may be as long or as short as desired. For example, the period of time may be less than 1 second, 1 second, 5 seconds, 30 seconds, 1 minute, 5 minutes, 30 minutes, 1 hour, or more than 1 hour. In various embodiments, step 735 may comprise turning the servo on. In various embodiments, a calibration procedure is not performed by the servo following step 735. In various embodiments, step 740 may comprise repeating steps 710, 715, 720, and 725. In this manner, the servo may rotate by any amount of rotation, turn off, turn back on, and resume operation by rotating the servo without requiring a calibration procedure to be run in order to determine the OP.

Some non-limiting examples of this disclosure are now discussed. In an exemplary embodiment, t₁ may represent the number of teeth for a first gear, t₂ may represent the number of teeth for a second gear, n is an integer which represents the number of full rotations of the second gear for the first gear to rotate once, and g may represent the gear ratio of a gearbox. In this exemplary embodiment, t₁=10, n=0, and g=8. Using the equation t₁/t₂=n+ (1/g), t₂ can be calculated as 80. For such a combination of parameters, upon one full rotation of the first gear, the second gear will rotate 45 degrees, or put another way, the second gear will complete ⅛ of a rotation for each full rotation of the first gear. As it is calculated that every 8 rotations of the first gear will result in 1 rotation of the second gear, OP may be measured, for example by measuring the angular position of the first gear and the second gear.

In an exemplary embodiment, it may be desirable to physically separate a first encoder input and a second encoder input which are physically attached to the first gear and the second gear respectively. In this manner the interference of the magnetic fields of the first encoder input and the second encoder input may be minimized, along with other design considerations. Such a result may be achieved by selecting a different n value than in the previous exemplary embodiment. For example, where t₁=45, n=1, and g=8, t₂ can be calculated as 40. In this exemplary embodiment, upon one full rotation of the first gear, the second gear will rotate 405 degrees, or put another way, the second gear will complete 1 and ⅛ of a full rotation for each full rotation of the first gear. After 8 full rotations of the first gear, the rotation of the second gear becomes zero. Between 0 rotation of the first gear and 8 full rotations of the first gear there may be a unique angle combination provided by a first encoder and a second encoder reading the first encoder input and the second encoder input respectively. The unique angle combination may act as a counter, allowing OP to be calculated using the formula OP=(a₁/g)+quotient {mod [a₂−a₁×(n+1/g), 360], (360/g)}× (360/g), where a₁ represents an angle reading from the first encoder of the first encoder input and where a₂ represents an angle reading from the second encoder of the second encoder input. The first encoder and the first encoder input may be a high precision encoder pair. The second encoder and the second encoder input may be used to detect which ⅛th rotation the second gear is in, where the ⅛th rotation corresponds to 1-8 full rotations of the first gear. The first portion of the equation, (a₁/8) provides the precise angle within the ⅛th rotation section for the second gear, while the second portion of the equation, quotient {mod [a₂−a₁×(1+1/8), 360], (360/8) provides the ⅛th rotation section, which is then multiplied by (360/8) and added to the first portion of the equation to calculate the final OP angle.

For example, for two angle measurements a₁=140 degrees and a₂=157.5 degrees, the quotient may be calculated to be zero as the rotation is in the first ⅛th section, and the OP calculation formula provides OP=17.5 degrees. For example, for two angle measurements a₁=140 degrees and a₂=292.5 degrees, the quotient may be calculated to be 3 as the rotation is in the fourth ⅛th section, and the OP calculation formula provides OP=152.5 degrees. The exemplary calculations provided herein are non-limiting. The OP calculation formula may apply to any other values of n and g not specifically described herein.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The term “bearing” and the like in the description and in the claims, if any, is used to describe a mechanism for coupling elements while reducing friction between the elements, and is used for descriptive purposes and not necessarily for describing necessary components. It is to be understood that the terms so used may be interchangeable under appropriate circumstances with any suitable mechanism for coupling elements while reducing friction between the elements in the desired configuration. For example, a bearing as described herein may be replaced with a bushing when appropriate.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although systems and methods for servo motor output angle measurement with a mechanical counter system on the driver side have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that various elements of FIGS. 1-7 may be modified, and that the foregoing discussion of certain of these embodiments does not necessarily represent a complete description of all possible embodiments. For example, one or more of the procedures, processes, or activities of FIG. 7 may include different procedures, processes, and/or activities and be performed by many different modules, in many different orders.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A servo, comprising:
a gearbox;
a servo output positioned on an output side of the gearbox;
a first encoder positioned on a board side of the gearbox;
a first encoder input configured to communicate with the first encoder and mechanically coupled to the gearbox;
a second encoder positioned on the board side of the gearbox; and
a second encoder input, configured to communicate with the second encoder and mechanically coupled to the first encoder input,
wherein the output side of the gearbox is opposite the board side of the gearbox.

2. The servo of claim 1, wherein the first encoder input is mechanically coupled to the gearbox by a first gear, the first gear fixedly coupled to the gearbox and the first encoder input fixedly coupled to the first gear.

3. The servo of claim 2, wherein the first encoder input is mechanically coupled to the second encoder input by a second gear, the second gear mechanically coupled to the first gear and the second encoder input fixedly coupled to the second gear.

4. The servo of claim 3, wherein the first gear has t₁ teeth, wherein the second gear has t₂ teeth, wherein g represents a gear ratio of the gearbox, wherein n represents an integer, and wherein t₁/t₂=n+ (1/g).

5. The servo of claim 4, further comprising a third gear, the third gear mechanically coupled between the first gear and the second gear and configured to act as a mechanical transmission element.

6. The servo of claim 3, wherein the first encoder and the second encoder each independently comprise a diametric magnet encoder, a multi-pole magnetic encoder, an optical encoder, or a capacitive encoder.

7. The servo of claim 6, wherein the first encoder and the second encoder each comprise a diametric magnet encoder.

8. The servo of claim 7, wherein the first encoder input and the second encoder input each comprise a diametric magnet.

9. The servo of claim 1, wherein the gearbox comprises a planetary gearbox, a harmonic gearbox, or a cycloidal gearbox.

10. The servo of claim 9, wherein the gearbox comprises a planetary gearbox comprising a sun gear, a sun gear pin, and one or more planet gears.

11. The servo of claim 10, wherein the sun gear pin comprises a hollow shaft, the hollow shaft configured to allow electrical wires to be routed through a middle of the servo.

12. The servo of claim 1, further comprising a timing belt and wherein:
the first encoder input is mechanically coupled to the gearbox by a first timing belt pulley, the first timing belt pulley is fixedly coupled to the gearbox and the first encoder input is fixedly coupled to the first timing belt pulley;
the second encoder input is fixedly coupled to a second timing belt pulley; and
the first timing belt pulley is mechanically coupled to the second timing belt pulley by the timing belt.

13. The servo of claim 1, wherein the first encoder input is directly coupled to the gearbox.

14. A method for determining a servo output position, the method comprising:
rotating, by a gearbox, a servo output of a servo;
in response to the rotating, changing a set position of a first encoder input and a second encoder input, the first encoder input and the second encoder input being mechanically coupled to the gearbox;
detecting, by a first encoder, a first position of the first encoder input;
detecting, by a second encoder, a second position of the second encoder input; and
calculating, by one or more processors, an output angular position associated with the rotation of the servo output based on the first position and the second position.

15. The method of claim 14, wherein the changing the set position of the first encoder input is caused by a first gear having t₁ teeth, the first gear mechanically coupled between the gearbox and the first encoder input.

16. The method of claim 15, wherein the changing the set position of the second encoder input is caused by a second gear having t₂ teeth, the second gear mechanically coupled between the first gear and the second encoder input, wherein g represents a gear ratio of the gearbox, wherein n represents an integer, and wherein t₁/t₂=n+ (1/g).

17. The method of claim 14, further comprising:
turning the servo off for a period of time;
after the period of time, turning the servo on; and
repeating the steps of changing, detecting, and calculating,
wherein a calibration procedure is not performed by the servo following the turning the servo on.

18. The method of claim 14, wherein the first encoder and the second encoder are positioned on a first side of the gearbox and wherein the servo output is positioned on a second side of the gearbox.

19. The method of claim 14, wherein the first encoder input and the second encoder input each comprise a diametric magnet and wherein the first encoder and the second encoder each comprise a diametric magnet encoder.

20. A servo, comprising:
a gearbox;
a servo output positioned on an output side of the gearbox; and
a first encoder and a second encoder positioned on a board side of the gearbox,
wherein the first encoder and the second encoder are mechanically coupled to the gearbox and configured to determine an angular position of the servo output, and
wherein the output side of the gearbox is opposite the board side of the gearbox.
